(19) United States
(12) Patent Application Publication
(10) Pub. No.: US 2004/0022345 A1
(43) Pub. Date: Feb. 5, 2004

(54) Arrangement device for storage and / or transport of radioactive materials

(75) Inventors: Yann Hermouet, Guyancourt (FR); Alexandre Biguet, Neuilly Plaisance (FR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Cogema Logistics

(21) Appl. No.: 10/459,772

(22) Filed: Jun. 11, 2003

(30) Foreign Application Priority Data
Jun. 13, 2002 (FR) 02 07261

(51) Int. Cl. G21C 19/00

(52) U.S. Cl. 376/272

(57) ABSTRACT

The invention relates to an arrangement device (1) for the storage and/or transport of nuclear fuel assemblies, the device (1) comprising a plurality of compartments (2) capable of receiving at least one nuclear fuel assembly, each compartment (2) being made of a plurality of wall elements (6, 8, 10) that form the sidewall of the compartment (2), at least one connection between two elements (6, 8) of the compartment (2) wall being made using one engagement portion (12) and a complementary engagement portion (14), respectively formed on said two wall elements (6, 8) of the compartment (2). According to the invention, the engagement portion (12) and the complementary engagement portion (14) each contain a dovetail-shaped part that fits into the other, along a direction approximately parallel to a longitudinal axis (4) of the compartment.

### TECHNICAL FIELD

The present invention relates to an arrangement device for storage and/or transport of radioactive materials such as nuclear fuel assemblies, after these assemblies have been irradiated in a nuclear reactor.

### STATE OF PRIOR ART

This type of arrangement device, also called arrangement “baskets” or “racks”, have several compartments within which irradiated nuclear fuel assemblies can be placed in order to be stored and/or transported.

In the nuclear industry, fuel assemblies form the energy source of nuclear power stations, and consequently need to be stored and/or moved during a time period after the end of their use as an energy source for the power station, and before their interim storage in reprocessing sites.

Arrangement devices are used for storing irradiated fuel assemblies in nuclear power stations or in reprocessing sites, or for the transport of these irradiated fuel assemblies, for example between nuclear power stations and reprocessing sites.

This type of storage device must perform several functions. In particular, these functions include mechanical strength and stowage of radioactive materials, and ease of handling.

Furthermore, depending on the nature of the radioactive materials, the arrangement device must perform various functions related to nuclear safety during transport or storage. These functions include mainly the need to evacuate the heat flow produced by materials contained in the device and control of nuclear criticality, when these materials are fissile materials that could cause a chain reaction.

The purpose of the mechanical strength function is to maintain the geometry of the device during handling operations, under the effect of accelerations that occur during transport, and also in the case of a shock or accidental drop, to keep nuclear criticality under control under these circumstances. Furthermore, it is noted that regulatory checks have been carried out on these configurations.

Thus, the tests to be carried out to satisfy these regulatory requirements and obtain the required approval to perform the transport/storage of nuclear fuel assemblies, include various tests such as the “free drop” test, particularly including the 9-meters drop.

Several embodiments have already been proposed in this technical field.

Devices for the storage of nuclear fuel assemblies are normally provided with a plurality of adjacent compartments, each with a square or hexagonal cross-section so that a fuel assembly with a complementary shape can be inserted into and held in place in this compartment. In order to make the sidewalls of these compartments, usually used wall elements are made from a material alloyed with boron, boron being chosen due to its ability to absorb neutrons and consequently to control nuclear safety.

In a first type of embodiment according to prior art, devices are known in which the compartment sidewalls are made from stainless steel strips alloyed with boron. This solution enables this type of device to have a plurality of advantageous technical characteristics. The neutron poison making the device sub-critical and preventing reactions between the different fuel assemblies consists of boron, as mentioned above. Furthermore, the use of stainless steel to make the sidewalls of compartments provides additional gamma shielding, and very strong stiffness of the arrangement device.

It is noted that the strong stiffness characteristic of the device is particularly beneficial in that it enables the arrangement device to easily satisfy the above mentioned regulatory safety requirements for transport/storage of nuclear fuel assemblies.

As already mentioned above, by providing a sufficiently thick sidewall, the stainless steel strips making up this wall make it possible to successfully pass all these tests.

However, the use of such a material introduces non-negligible disadvantages.

Although the use of steel considerably increases the stiffness of the arrangement device, it also increases its weight, which is not always compatible with the requirement of a maximum weight not to be exceeded, this mass limitation being imposed by operating constraints.

Furthermore, when nuclear fuel assemblies are supported in their corresponding compartments in the arrangement device, it is essential that the sidewalls should be capable of dissipating residual heat emanating from the assemblies in interim storage. This heat transfer function is not performed very efficiently by stainless steel, and this serious disadvantage can cause dangerous overheating inside the arrangement device.

In order to overcome this problem, it has been proposed that the material mentioned above, namely a stainless steel and boron alloy, should be replaced by an aluminium and boron alloy in order to produce a material capable of firstly better dissipating residual heat, and secondly achieving equivalent control over nuclear criticality.

A first embodiment using this material was used in prior art, this embodiment consisting of a stack of cast aluminium and boron alloy structures, with openings to define the compartments. However, it very quickly became clear that with this type of solution, it was impossible to make the storage arrangement with sufficient stiffness to be able to satisfy regulatory safety requirements for transport/storage of nuclear fuel assemblies, mainly due to the poor mechanical strength properties of cast aluminium.

Furhermore, apart from the problem related to the stiffness of the device, another disadvantage related to the use of such a material is due to the difficulty in obtaining a uniform distribution of boron in aluminium during casting, which leads to situations in which the device would not be kept in the sub-critical state.

Furthermore, other embodiments according to prior art suggested making a connection between wall elements made of aluminium and boron alloy, made by extrusion in order to increase the stiffness compared with wall elements made of cast aluminium.

Thus, according to prior art, devices are known in which the wall elements forming the sidewall of compartments are connected to each other by welding operations. However, the welding technique necessary to assemble these wall elements is electron beam welding, and this expensive technique inevitably increases manufacturing costs incompatible with the need to design cost effective devices. Furthermore, welding between two wall elements made of aluminium and boron alloy can cause a slight deformation of these elements, so that the compartments can no longer contain the nuclear fuel assemblies and/or keep them in place.

Another solution envisaged in prior art is related to the use of screwed interlocking type connections between two wall elements of the same compartment, this solution not being very efficient due to the difficulty encountered in establishing a rigid link between a screw and a threaded orifice in the aluminium. Furthermore, it is noted that an increase in the number of parts making up the arrangement device causes the occurrence of major disadvantages, particularly in terms of speed of assembly and global cost of the device.

Finally, the last solution proposed for assembling two wall elements perpendicular to a sidewall of the same compartment is described in document WO-A-00/72325. This technique consists of providing a plurality of engagement portions along the longitudinal edge of the first wall element, and providing several complementary engagement portions on a face of the second wall element, these latter complementary engagement portions being designed to co-operate with engagement portions located on the edge of the first element. In this way, the two elements can be assembled by bringing the engagement portions and the complementary engagement portions towards each other and then force fitting them one into the other.

However, the connection type obtained using engagement portions and complementary engagement portions introduces disadvantages that are extremely serious for an arrangement device with this type of connection. Some of these portions project outwards so that they can be force fitted into others that are recessed.

One of the problems that occurs during use of these connections is that it is impossible to disassemble and then reassemble wall elements making up the sidewall of the compartments. To disassemble the two wall elements after they have been assembled together, the engagement portions and/or the complementary engagement portions provided on the two elements must be damaged so that their assembly is broken, which inevitably makes it impossible to reuse these elements. Note also in addition to the fact that it is impossible to reuse the wall elements, that this type of connection obtained by force fitting introduces serious difficulties in disassembling the device, for example during operations related to maintenance of the device.

Another disadvantage related to this type of proposed connection is the poor support that it provides between the two wall elements. In other words, despite the plurality of co-operating portions between the two perpendicular wall elements of the same compartment, this connection is still composed of several isolated fasteners distributed over the contact surface between the two elements to be assembled. Consequently, the isolated fasteners forming the connection do not necessarily provide a sufficiently rigid support to enable the arrangement device to satisfy the regulatory safety requirements for transport/storage of nuclear fuel assemblies. Note that this disadvantage is further amplified when the wall elements are made of a material like an aluminium and boron alloy that does not have high stiffness characteristics, however this is the material that should be used to maintain sub-criticality and the heat transfer function of the device.

### SUMMARY OF THE INVENTION

Therefore, the object of the invention is to provide an arrangement device for storage and/or transport of radioactive materials such as nuclear fuel assemblies, the device at least partially correcting the disadvantages mentioned above related to implementations in prior art.

More precisely, the object of this invention is to provide an arrangement device comprising a plurality of compartments, each capable of holding at least one nuclear fuel assembly and in which at least one connection between two wall elements of the sidewall of each compartment is made with a simple design and provides a reinforced support between the two wall elements, particularly with respect to the support generated by the connections encountered in devices according to prior art.

In order to achieve this, the invention is related to an arrangement device for storage and/or transport of radioactive materials such as nuclear fuel assemblies, the device comprising a plurality of compartments each capable of receiving at least one nuclear fuel assembly, each compartment being made of a plurality of wall elements that when assembled together form the sidewall of the compartment, at least one connection between two elements of the compartment wall being made using at least one engagement portion and a complementary engagement portion, respectively formed on said two wall elements of the compartment. According to the invention, the engagement portion and the complementary engagement portion each contain a dovetail-shaped part that fits into the other, along a direction approximately parallel to the longitudinal axis of the compartment.

Advantageously, firstly due to the dovetail shape of part of the engagement portion and part of the complementary engagement portion, and secondly the direction along which they slide, this type of connection can give increased support between the two wall elements provided with said portions, particularly with respect to the support obtained in devices according to prior art. The chosen dovetail shape is a means of making the engagement portion and the complementary engagement portion co-operate over a determined length, this length advantageously extending over the entire contact length between the two elements on which these portions are fitted. The connection obtained thus provides a support with forces participating in the stiffness of the connection being distributed linearly along the wall elements, rather than in an isolated manner as was the case in embodiments according to prior art.

Furthermore, the dovetail shape and the engagement direction enable relatively easy assembly and disassembly of the two wall elements, by carrying out simple sliding operations between these elements, and not causing any damage to the elements. Furthermore, it is noted that with this type of connection, it is naturally possible to very precisely respect the geometry of the compartments, in order to enable the nuclear fuel assemblies to be inserted and well maintained inside them.

It is also possible to enable each of the engagement portion and the complementary engagement portion to have a part other than the dovetail-shaped part, the other parts being in contact with the dovetail-shaped parts corresponding to them. According to another alternative, it is also possible to arrange matters such that the engagement portion and the complementary engagement portion are composed of dovetail-shaped parts only.

According to one preferred embodiment of the invention, the sidewall of at least some of the plurality of compartments is made by using wall elements belonging to a first set of wall elements, and wall elements belonging to a second set of wall elements, the wall elements in the second set being arranged approximately perpendicular to the wall elements in the first set.

Thus, all these compartments may have an approximately square cross section, this shape being quite suitable for holding nuclear fuel assemblies that are usually square.

Preferably, the wall elements of the first set each comprise an engagement portion projecting outwards at least one longitudinal edge of this element, and the wall elements of the second set each comprise at least one face provided with at least one complementary recessed engagement portion. Thus, several compartments in the storage device each comprise several reinforced support connections, causing an increase in the stiffness of the device. It is noted that the increase in the stiffness of the device is quite appreciable, particularly in order to satisfy the free drop test of 9 meters.

Preferably, each wall element in the second set partially forms the sidewall of at least two compartments of the device, consequently considerably reducing the number of connections to be made between wall elements of different compartments, and the time necessary to assemble and disassemble the device.

It would also be possible for the elements of the first and second sets of elements of the wall to be made from an aluminium and boron alloy, so that they can optimise heat transfer and control of nuclear criticality.

Preferably, wall elements located at the periphery of the device are made of stainless steel and are installed by screwing onto the wall elements of the first and second sets of wall elements. Advantageously, the wall elements arranged around the periphery of the device even further increase the global stiffness of the device, and provide further gamma shielding.

Finally, it could be arranged for the device to include a lower perforated end piece and an upper perforated end piece, the end pieces being made of stainless steel and installed by screwing onto the wall elements around the periphery of the device.

Other advantages and characteristics of the invention will become clear after reading the non-limitative detailed description given below.

### BRIEF DESCRIPTION OF THE DRAWINGS

This description will be made with regard to the attached drawings in which:

FIG. 1 shows a partially exploded perspective view of part of an arrangement device according to a preferred embodiment of this invention;

FIG. 2 shows a perspective view of part of an arrangement device according to another preferred embodiment of this invention;

FIG. 3a shows a sectional view of an assembly between two wall elements of the arrangement device shown in FIG. 2;

FIG. 3b shows a cross-sectional view of an assembly between two wall elements of a storage device according to another preferred embodiment; and

FIG. 4 shows a sectional view according to a plane perpendicular to the longitudinal axis of the arrangement device shown in FIG. 1.

### DETAILED DESCRIPTION OF PREFERRED EMBODIMENTS

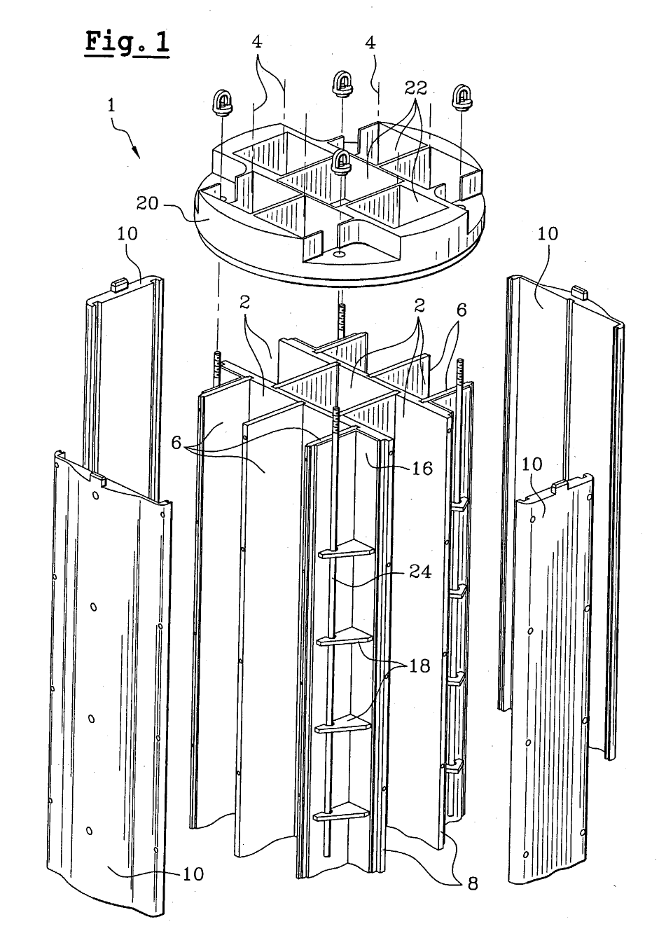

FIG. 1 illustrates an arrangement device 1 for storage and/or transport of radioactive materials such as nuclear fuel assemblies (not shown) according to a preferred embodiment of this invention.

As can be seen in FIG. 1, the arrangement device 1 comprises a plurality of compartments 2 arranged in parallel, these compartments each being extended along a longitudinal axis 4. Each of the compartments 2 can hold at least one and preferably only one square fuel assembly, such that the longitudinal axis 4 of the compartment 2 is approximately parallel to the longitudinal axis of the fuel assembly supported in this compartment 2.

The compartments 2 are designed so that they can be arranged adjacent to each other, and are made through a set of several wall elements 6, 8 and 10, some of which are common to several compartments 2 of the device 1. When they are assembled together, the wall elements 6, 8 and 10 form the sidewall of each of the compartments 2, this sidewall preferably having an approximately square cross section, but that can also adapt other forms capable of holding a fuel assembly with a different shape such as a hexagonal shape in place.

To enable the compartments 2 to have an approximately square cross section, the wall elements 6, 8 and 10 are assembled to each other so that they can be arranged in parallel and perpendicular to each other. In this respect, it is noted that the wall elements 6, 8 and 10 are distributed in three separate sets of elements, defined by a first set of wall elements and a second set of wall elements and a set of peripheral wall elements, respectively.

Still with reference to FIG. 1, the assembly between the wall elements 6 of the first set of wall elements, and the wall elements 8 of the second set of wall elements can be seen. The elements 6 are arranged parallel to each other, in the same way as the elements 8 are parallel to each other. Furthermore, the wall elements 6 are assembled so that they are approximately perpendicular to the wall elements 8.

It is noted that as can be seen in FIG. 1, in this preferred embodiment the wall elements 6 and 8 each extend along the entire length of the compartment(s) 2 that they form, so that each of them forms a plane side face of the wall of one or several compartments 2.

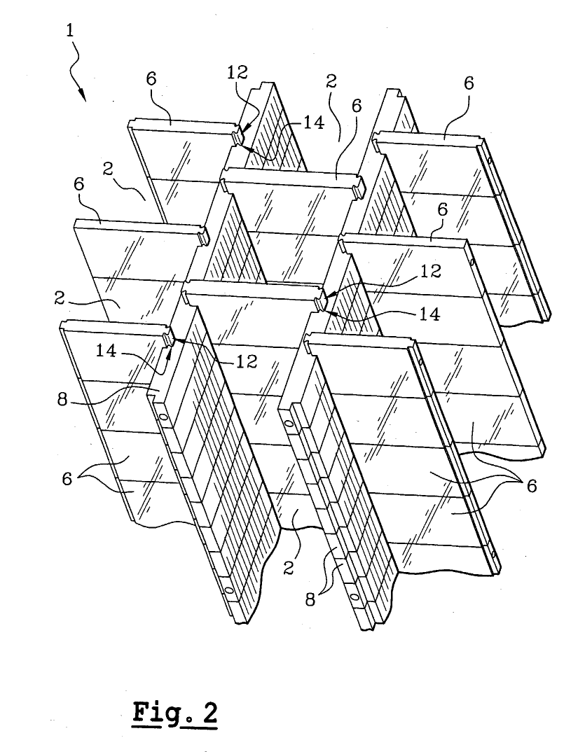

However, the wall elements 6 and 8 are preferably made by extrusion in an aluminum and boron alloy. Thus, the maximum height of these wall elements 6 and 8 is relatively limited, which can mean that they are stacked along the longitudinal axis of the compartment(s) that they form, as shown in FIG. 2 that partially shows another preferred embodiment of the device 1. The maximum allowable height is greater when the thickness of the wall element concerned is thinner. Consequently, since the wall elements 6 are thicker than the wall elements 8 for mechanical strength reasons, the maximum allowable height of the wall elements 6 is greater than the maximum allowable height of the wall element 8.

Furthermore, as shown in FIG. 2, the stack of wall elements 6 and 8 is preferably made such that the transverse edges of the wall elements 6 are never in the same plane as the transverse edges of the wall elements 8. This particular arrangement has the advantage of improving the stiffness of the arrangement device 1.

In the described preferred embodiments, the arrangement device 1 comprises seven compartments 2 arranged such that each of the two wall elements 8 or each of the two stacks of wall elements 8 partially define the sidewall of three compartments 2 by means of one of its faces, and the sidewall of two compartments 2 using its other face. Furthermore, it is noted that the faces of the elements 8 or the stacks of elements 8 partially defining the sidewall of the three compartments 2, are placed facing each other such that the two elements 8 or the two stacks of elements 8 belong to the sidewall of the same three compartments 2.

As can be seen in FIG. 2, each of the wall elements 6 in the first set of wall elements is assembled on at least one of the wall elements 8 in the second set of wall elements.

For each compartment 2 in the device 1, at least one connection between two wall elements 6 and 8 is such that one element is provided with an engagement portion 12 co-operating with a complementary engagement potion 14 provided on the other of the elements 6 and 8.

Preferably, each of the connections between the elements 6 and 8 of the first and second sets of wall elements is made in the same way.

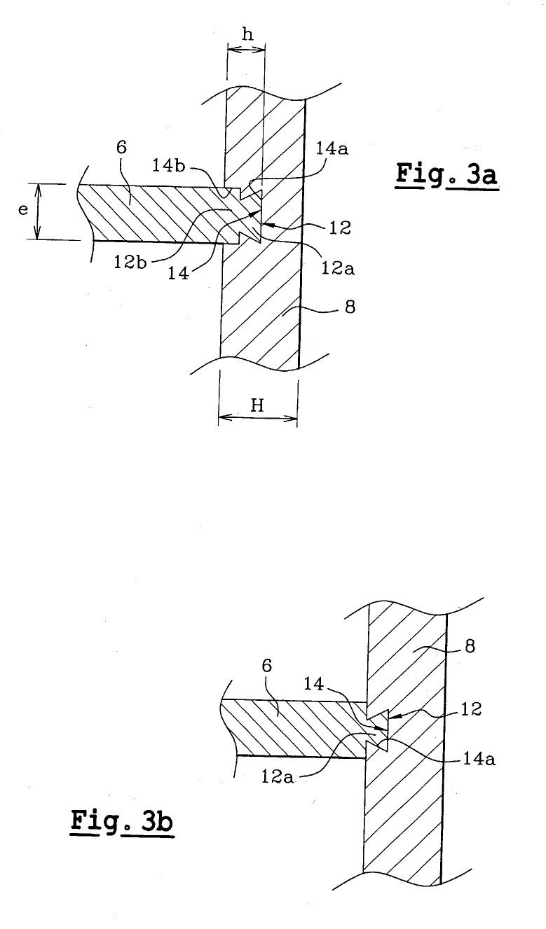

More specifically and with reference to FIGS. 2 and 3a, for two arbitrary elements 6 and 8 in contact, the engagement portions 12 and the complementary engagement portions 14 each comprise a dovetail-shaped part 12a, 14a capable of engaging in each other along a direction approximately parallel to the longitudinal axis 4 of the compartment 2 composed partially of the arbitrary elements 6 and 8.

Thus, the connection generated by co-operation between the engagement portion 12 and the complementary engagement portion 14 may extend over the entire contact length between the two elements on which these two portions are contained. In this way, the dovetail-shaped complementary portions 12a and 14a are extended over a relatively long length, or even over the entire contact length between the two elements 6 and 8 provided with these shapes, the connection obtained between the two elements 6 and 8 or the two stacks of elements 6 and 8 provide a particularly rigid support between these elements.

It is noted that for a given connection, the engagement portion 12 and the complementary engagement portion 14 have approximately the same shape, one projecting outwards and the other being recessed. It is also preferable to have a small clearance of the order of a tenth of a millimetre between the two portions 12 and 14 so as to facilitate one sliding into the other when the wall elements 6 and 8 are assembled or disassembled.

Furthermore, due to the direction of the engagement between the dovetail-shaped parts 12a and 14a, the wall elements 6 and 8 of the first and second set of wall elements are assembled and disassembled simply by sliding the engagement portions 12 and the complementary engagement portion 14, thus facilitating execution of these operations without causing any deterioration to the elements 6 and 8. Furthermore, this particular arrangement makes it easy to stack the wall elements 6 and the wall elements 8. Furthermore, it would be advantageous to provide engagement portions 12 and complementary engagement portions 14 over the entire contact length between the different stacks.

In the preferred embodiment described with reference to FIG. 3a, the engagement portion 12 comprises firstly the dovetail-shaped portion 12a and secondly an approximately parallelepiped shaped part 12b on which part 12a is supported. Note that in the preferred embodiment described, the part 12b is a portion of the wall element 6 with exactly the same thickness as the average thickness of this element 6. However, without going outside the scope of the invention, it will naturally be possible to use any appropriate shape for the part 12b of the engagement portion 12, so that this part enables sliding of the wall elements 6 and 8.

Similarly, the complementary engagement portion 14 comprises firstly the dovetail-shaped part 14a and secondly a part 14b with a shape approximately complementary to part 12b and in contact with the dovetail-shaped part 14a. Therefore, in the embodiment shown in FIG. 3a, the part 14b of the portion 14 is in the shape of a groove with approximately the same width as the average thickness of the wall element 6, except for the clearance.

Consequently, the connection between the wall elements 6 and 8 consists of a dovetail-shaped interlock using parts 12a and 14a of the engagement portion 12 and the complementary engagement portion 14, and a tenon/plane type interlock by means of parts 12b and 14b, before the dovetail type interlock. Obviously, and as mentioned above, the tenon/plane interlock is made in an arbitrary manner, while enabling the dovetail-shaped parts 12a and 14a to slide along a direction approximately parallel to the axes 4 of the compartments 2.

For example, and still with reference to FIG. 3a, and noting the thickness of the element 6 to be e, the thickness of element 8 to be H, and the length of the engagement portion 12 penetrating into the element 8 to be h, it is preferable if these parameters satisfy the following algebraic relations:

H=2e/3 and H=4e/3

In another preferred embodiment shown in FIG. 3b, the engagement portion 12 and the complementary engagement portion 14 are composed only of the dovetail-shaped parts 12a and 14a respectively.

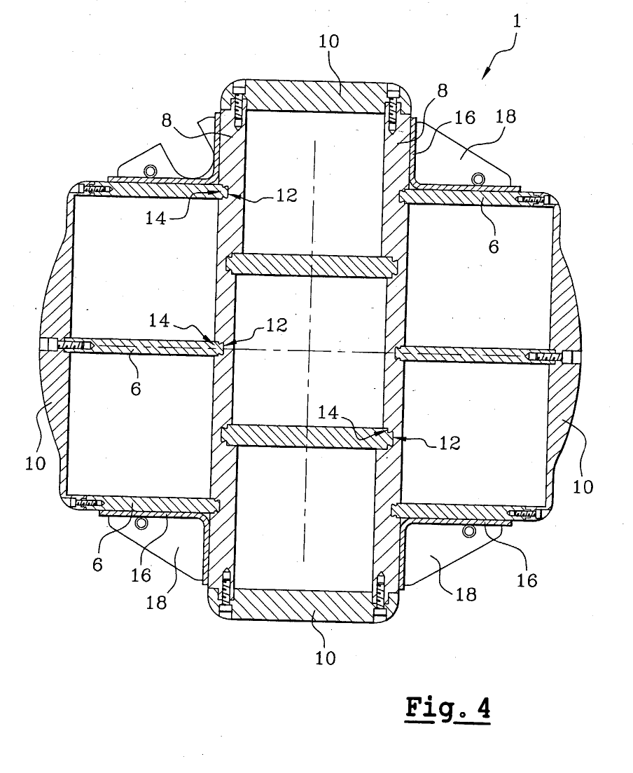

As can be seen better in FIG. 4, each wall element 6 in the first set of wall elements is provided with an engagement portion 12 like those that have just been described, on at least one of its two longitudinal edges. Furthermore, each wall element 8 in the second set of wall elements is provided with several complementary recessed engagement portions 14 on each of its two faces, such as one of those described above, these complementary portions each co-operating with the engagement portion 12 of a wall element 6. The recessed portions 14 with projections 12 are easily made by machining, and obviously may be located indifferently on the elements 6 of the first set of wall elements, or on the elements 8 of the second set of wall elements. In the example shown, they form compartments for which the square section may be different as a function of the compartments 2 considered. Obviously, it would also be possible for all the compartments 2 to have the same square section without going outside the scope of the invention.

The wall elements 10 of the set of peripheral wall elements of the arrangement device 1 are installed by screwing on the wall elements 6 and 8, but they could naturally be fixed in the same way as was adopted for elements 6 and 8, namely by a system comprising complementary dovetail-shaped portions.

Preferably, the wall elements 6 and 8 in the first and second sets of wall elements are made from an aluminum and boron alloy in order to dissipate residual heat originating from the nuclear fuel assemblies placed in compartments 2 to keep the arrangement device 1 in a sub-critical state. On the other hand, the wall elements 10 in the set of peripheral wall elements are made from stainless steel so as to reinforce the stiffness of the device 1 and provide additional gamma shielding.

Still in order to reinforce the stiffness of the device 1, and particularly in order to satisfy the regulatory safety requirements for transport/storage of nuclear fuel assemblies, the device 1 may include lateral stiffeners 16 located around the periphery of the arrangement device 1 visible in FIGS. 1 and 4.

Each lateral stiffener 16 is preferably made of aluminium and has an L-shaped section so that it can be fixed flat by simultaneously screwing on two wall elements 6 and 8 arranged perpendicular to the periphery of the device 1.

The side stiffeners 16 advantageously extend over the entire length of the sidewall of the compartments 2, and are fitted with a plurality of brackets 18 at a spacing from each other, assembled by welding on each of the two L-shaped stiffener branches 16.

It is also possible to provide the device 1 with a perforated upper end piece and a perforated lower end piece (only the upper end piece being shown in FIG. 1 and denoted as numeric reference 20), these end pieces 20 being made with stainless steel and installed by screwing on the wall elements 10 of the set of peripheral wall elements. As can be seen in FIG. 1, the perforated upper end piece 20 is provided with openings 22 through which nuclear fuel elements can be inserted, each extending into a compartment 2 of the device 1.

Finally, note also the presence of tie rods 24 (FIG. 1) coupled to an elastic system (not shown) enabling displacements and forming the connection firstly between the elements 10 and secondly between the end pieces 20 of the device 1. These connections that have become mobile are provided due to the difference in material between the aluminium wall elements 6 and 8, and the wall elements 10 in the set of steel peripheral wall elements. Since the device is subjected to high thermal stresses, a thermal expansion phenomenon of the wall elements 6, 8 and 10 frequently occurs, this phenomenon obviously being greater on the aluminium wall elements 6 and 8 than on the steel wall elements 10.

Furthermore, the connections between the wall elements 6 and 8 in the first and second sets of wall elements made by means of complementary portions engaging with each other along a direction parallel to the longitudinal axes 4 of the compartments 2, are quite suitable for resisting the expansion phenomenon of elements 6 and 8. The main direction of thermal expansion of the elements 6 and 8 is parallel to the longitudinal axes 4 of the compartments 2, this direction also being the direction along which the engagement portions 12 and the complementary engagement portions 14 are likely to slide. Thus, with this type of connection, wall elements 6 and 8 made of different materials with different coefficients of expansion can be used, without causing breakage of these connections during a temperature variation inside the arrangement device 1. In this case, the wall elements 6 and 8 will be able to slide with respect to the others without causing any deterioration to their corresponding engagement portions.

Obviously, a person skilled in theort could make various modifications to the arrangement devices 1 as described above that are only given as non-limitative examples.

1. Arrangement device for storage and/or transport of radioactive materials such as nuclear fuel assemblies, said device comprising a plurality of compartments each capable of receiving at least one nuclear fuel assembly, each compartment being made of a plurality of wall elements that, when assembled, form the sidewall of the compartment, at least one connection between two wall elements of the compartment being made using one engagement portion and a complementary engagement portion, respectively formed on said two wall elements of the compartment, characterised in that said engagement portion and said complementary engagement portion each contain a dovetail-shaped part that fits into the other, along a direction approximately parallel to a longitudinal axis of said compartment.

2. Arrangement device according to claim 1, characterised in that the engagement portion and the complementary engagement portion also each have a part other than the dovetail-shaped part, the other parts being in contact with the dovetail-shaped parts.

3. Arrangement device according to claim 1, characterised in that the engagement portion (12) and the complementary engagement portion are composed of dovetail-shaped parts only.

4. Arrangement device according to any one of claim 1, characterised in that for each connection made using an engagement portion and a complementary engagement portion, the engagement portion and the complementary engagement portion co-operate over the entire contact length between the wall elements on which said portions are fitted.

5. Arrangement device according to any one of claim 1, characterised in that the sidewall of at least some of the plurality of compartments is made by using wall elements belonging to a first set of wall elements, and wall elements belonging to a second set of wall elements, the wall elements in the second set being arranged approximately perpendicular to the wall elements in the first set.

6. Arrangement device according to claim 5, characterised in that the wall elements of the first set each comprise an engagement portion projecting outwards from at least one longitudinal edge of this wall element, and in that the wall elements of the second set each comprise at least one face provided with at least one complementary recessed engagement portion.

7. Arrangement device according to claim 5 or claim 6, characterised in that each wall element in the second set partially forms the sidewall of at least two compartments of said device.

8. Arrangement device according to any one of claim 5, characterised in that the wall elements of the first and second sets of wall elements are made from an aluminium and boron alloy.

9. Arrangement device according to any one of claim 5, characterised in that the wall elements of the first and second set of wall elements are assembled and disassembled by sliding the engagement portions in the complementary engagement portions.

10. Arrangement device according to any one of claim 5, characterised in that the wall elements located around the periphery of the device are made of stainless steel and are installed by screwing on the wall elements of the first and second sets of wall elements.

11. Arrangement device according to claim 10, characterised in that it also includes a lower perforated end piece and an upper perforated end piece, said end pieces being made of stainless steel and installed by screwing onto the wall elements around the periphery of said device.
